(19) United States
(12) Patent Application Publication
(10) Pub. No.: US 2006/0127752 A1
(43) Pub. Date: Jun. 15, 2006

(54) Battery with printed circuit

(75) Inventors: Matthew James Gray, Brighton, MI (US); John Scales, Ann Arbor, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/008,870

(22) Filed: Dec. 9, 2004

(51) Int. Cl. H01M 2/14; H01M 2/24

(52) U.S. Cl. 429/129; 429/65; 429/121; 429/158

(57) ABSTRACT

An apparatus (10) includes a battery (12) that has a positive terminal (50) and a negative terminal (52). At least one layer of electrical insulating material (60) is disposed on one of the positive terminal (50) and the negative terminal (52). At least one electrically conductive circuit layer (62) is disposed on the at least one layer of electrical insulating material (60).

### TECHNICAL FIELD

The present invention relates to a battery and, more particularly, to a battery with a printed circuit formed thereon.

### BACKGROUND OF THE INVENTION

It is known to provide a battery as a source of electrical energy for powering a circuit of an electrical or electronic device. Typically, the battery is a separate component that is installed on the device as an end stage in manufacture of the device or by a user of the device. For example, the battery may be installed in a housing which also supports the components of the circuit. As another example, the battery may be installed in a receiving device, such as a socket, that is mounted on a circuit board (e.g., a printed circuit board) upon which other circuit components are mounted.

In one particular application in the automotive industry, a remote keyless entry device, such as a fob or an ignition key, includes a printed circuit board and a separate battery mounted in a plastic housing. In another automotive application, a wireless tire pressure monitor for mounting on rotatable vehicle wheels includes printed circuit board, a pressure transducer, and a separate battery mounted in a plastic housing.

### SUMMARY OF THE INVENTION

In accordance with the present invention, an apparatus includes a battery that has a positive terminal and a negative terminal. At least one layer of electrical insulating material is disposed on one of the positive terminal and the negative terminal. At least one electrically conductive circuit layer is disposed on the at least one layer of electrical insulating material.

In accordance with another aspect of the present invention, an apparatus includes a battery including a positive terminal and a negative terminal. A printed circuit is formed on at least one of the positive and negative terminals.

### BRIEF DESCRIPTION OF THE DRAWINGS

The foregoing and other features and advantages of the invention will become apparent to one skilled in the art upon consideration of the following description of an exemplary embodiment of the invention and the accompanying drawings, in which:

FIG. 1 is a perspective view of an apparatus including battery and a printed circuit formed on a surface of the battery in accordance with an exemplary embodiment of the present invention;

FIG. 2 is a top view of the battery of FIG. 1;

FIG. 3 is a sectional view taken generally along line 3-3 in FIG. 2; and

FIG. 4 is a schematic view of a system in which the apparatus of FIGS. 1-3 is implemented.

### DESCRIPTION OF EMBODIMENTS

FIG. 1 illustrates an apparatus 10 in accordance with one exemplary embodiment of the present invention. The apparatus includes a battery 12 and a printed circuit 14 formed on the battery. The printed circuit 14 provides electrical connections to circuit components 16, which are mounted on the printed circuit. The circuit components 16 are thus fixed to the battery 12 along with the printed circuit 14. Traces 20 of the printed circuit 14 may provide electrical connections between certain circuit components 16 and between the circuit components and the battery 12.

The circuit components 16 can be any electrical or electronic device. For example, the circuit components 16 may include one or more discrete components (e.g., resistors, capacitors, inductors), solid state devices (e.g., transistors or diodes), and integrated circuits (e.g., IC chips implementing analog or digital circuitry). By way of further example, the circuit components 16 may also include sensors, transducers, and antennas. Those skilled in the art will understand and appreciate how any combination of circuit components can be arranged and configured to implement a desired function.

The battery 12 may be of any type suited to support and provide the required power to the printed circuit 14 and circuit components 16. In the illustrated embodiment, the battery 12 is a conventional “flat” battery that has a generally rounded and elongated configuration. As an example, the battery 12 may have a configuration similar or identical to that of known coin-shaped batteries, which may be used to power a variety of devices, such as remote keyless entry devices, watches, computer clock devices, etc. The battery 12 may also be of any known cell type, such as a lithium battery.

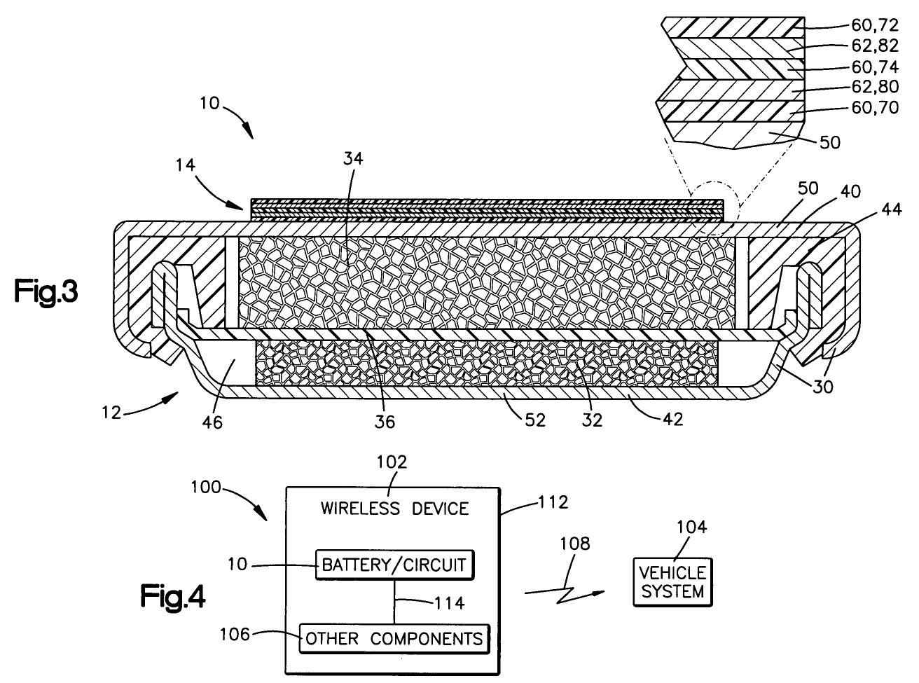

One exemplary construction of the apparatus 10 is illustrated in FIG. 3. Referring to FIG. 3, the battery 12 is a lithium battery. The battery 12 includes a case 30 that contains a mass of material forming an anode 32 and a mass of material forming a cathode 34 separated by an insulating material 36. In the lithium battery construction, the anode 32 comprises a lithium or lithium alloy material (e.g., a manganese lithium material). The battery case 30 includes a cathode or top case 40 and an anode or bottom case 42, each constructed of an electrically conductive material, such as stainless steel.

An insulating gasket 44 is positioned between the top case 40 and bottom case 42 to electrically isolate the cases from each other. The top and bottom cases 40 and 42 are crimped together to form a sealed chamber 46 in which the anode 32, cathode 34, and separator 36 are housed. In this assembled condition of the battery 12, the stainless steel top case 40 is pressed into abutting engagement with the cathode 34 and thus forms a positive terminal 50 of the battery. The stainless steel bottom case 42 is pressed into abutting engagement with the anode 32 and thus forms a negative terminal 52 of the battery 12.

According to the present invention, the printed circuit 14 is formed on a surface of the battery 12, i.e., the battery case 30. In the illustrated embodiment, the printed circuit 14 is formed on the top case 40, i.e., on the positive terminal 50 of the battery 12. The printed circuit 14 could, however, be formed on the bottom case 42, i.e., the negative terminal 52 of the battery 12. As another example, the apparatus 10 could include a printed circuit on both the top case 40 and the bottom case 42 of the battery 12.

In one embodiment, a process called “thick film printing” is used to print the printed circuit 14 onto the battery. Thick film printing involves printing layers of insulating material and electrically conductive material onto a substrate which, in the illustrated embodiment, is the positive terminal 50 of the battery 12. The layers are screened (e.g., silk screened) onto the positive terminal 50 in a known manner that may be similar or identical to those implemented in screening processes used to produce conventional printed circuit boards. Any other known method may be used to place the layers of insulating material and layers of conductive material on the battery 12.

The layers forming the circuit 14 include insulating layers 60 formed with the insulating material and circuit layers 62 formed with the electrically conductive material. The circuit layers 62 include the traces 20 that form the electrical connections of the circuit 14. The circuit layers 62 may include layers with connection traces, layers with ground traces, layers with positive traces, layers with negative traces, or layers having combinations of connection, positive, negative, and ground traces. Although the traces 20 have been illustrated as generally straight, thin lines, it will be understood and appreciated that the traces may have any desired shape or configuration.

As shown in FIG. 3, the circuit 14 includes an insulating layer 60 printed on the positive terminal 50 of the battery 12. Alternating circuit layers 62 and insulating layers 60 are printed on top of this initial insulating layer. It will be understood and appreciated that the circuit 14 may include any desired number of circuit layers and insulating layers. The circuit 14 may include as few as a single insulating layer 60 and a single circuit layer 62.

In the illustrated embodiment, the insulating layers 60 include a bottom insulating layer 70 and a top insulating layer 72 of the circuit 14. The bottom insulating layer 70 is disposed on the positive terminal 50 of the battery 12. The circuit layers 62 include a bottom circuit layer 80 and a top circuit layer 82. The bottom circuit layer 80 is disposed on the bottom insulating layer 70. The insulating layers 60 also include a middle insulating layer 74 disposed on the bottom circuit layer 80. The top circuit layer 82 is disposed on the middle insulating layer 74. The top insulating layer 72 is disposed on the top circuit layer 82.

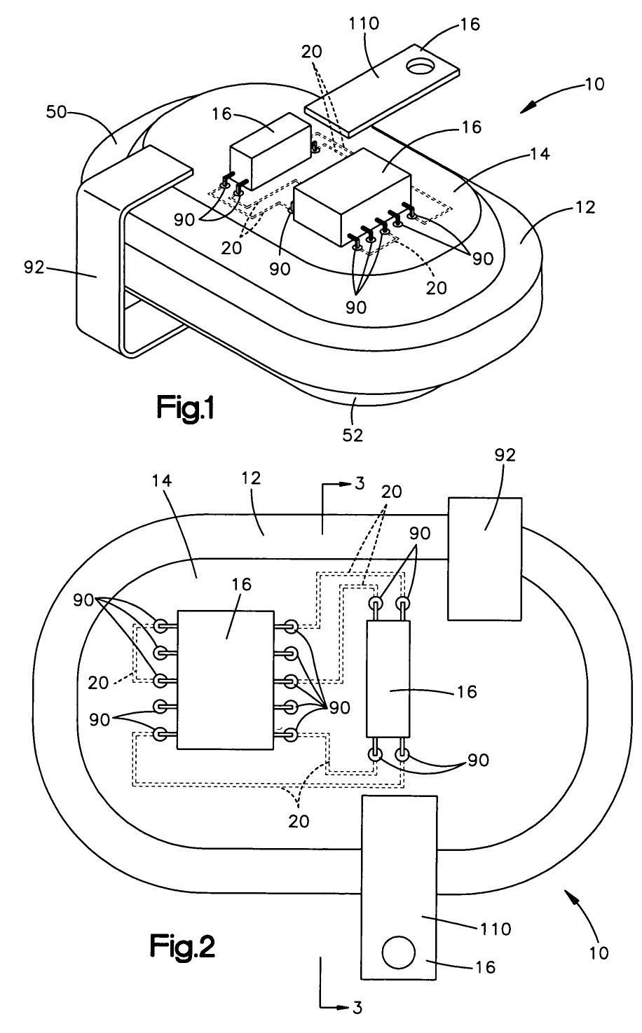

The bottom insulating layer 70 may leave selected portions of the positive terminal 50 of the battery 12 exposed in order to provide an electrical connection between the positive battery terminal and the bottom circuit layer 80. The middle insulating layer 74 may leave selected portions of the bottom circuit layer 80 exposed in order to provide an electrical connection between the bottom circuit layer and the top circuit layer 82. The top insulating layer 72 may leave selected portions of the top circuit layer 82 exposed in order to provide for establishing an electrical connection between the circuit 14 and the circuit components 16. For example, the top insulating layer 72 may leave portions of the top circuit layer 82 exposed to form pads 90 (see FIGS. 1 and 2) where the circuit components 16 may be connected to the circuit traces 20 by conventional means, such as selective soldering or re-flow soldering.

The apparatus 10 may also include a metal lead or strap 92 that has a portion connected to the negative terminal 52 (i.e., the bottom case 42) of the battery 12 and a portion connected to the circuit 14. The strap 72 may be connected to the negative terminal 52 by known means, such as welding (e.g., laser welding). The strap 72 may be connected to the circuit 14 by known means, such as soldering. The strap 72 provides an electrical connection between the negative terminal 52 of the battery 12 and the circuit 14, more specifically, the circuit layers 62.

The present invention allows for a reduced package size of the apparatus 10. This is because the need for a conventional circuit, separate from the battery 12 (e.g., a printed circuit board), is eliminated. This also eliminates the need to provide a connection, such as wires, a battery socket, etc., between the separate conventional circuit board and the battery 12. Mounting the apparatus 10 to a structure, such as a housing, is also simplified because only one part, i.e., the battery 12, needs to be mounted.

It will be understood and appreciated that the apparatus 10 of the present invention may have a variety of implementations. For example, the apparatus 10 may be used in an automotive environment to perform remote wireless sensing functions or remote wireless control functions. This is shown schematically in FIG. 4. Referring to FIG. 4, the apparatus 10 forms a portion of a system 100 that includes a wireless device 102 for providing wireless communication (e.g., via radio frequency signals) with a vehicle system 104. In this wireless configuration, one of the components 16 (see FIGS. 1 and 2) of the apparatus 10 may include an antenna 110 for providing wireless communication capabilities. Alternatively, the circuit layers 62 themselves may serve as an antenna for the apparatus 10.

The wireless device 102 may include a housing, indicated schematically at 112, to which the apparatus 10 is mounted. The apparatus 10 may form the entire electronic structure of the wireless device 102. Alternatively, as shown in FIG. 4, the wireless device 102 may also include a variety of other components 106 that help provide the desired functionality of the wireless device. The other components 106 may, for example, include other circuits or circuitry, electrical or electronic devices, circuit components (e.g., discrete components, solid state devices, integrated circuits), and manual input devices (e.g., pushbuttons). Also, the other components 106 may cooperate with the apparatus 10. For example, the other components 106 may have an electrical connection 114 with the apparatus 10 for communicating with the apparatus or for drawing power from the apparatus.

By way of example, in one particular embodiment, the wireless device 102 may comprise a wireless tire pressure monitoring device for installation on rotatable wheels of a vehicle (not shown). In this embodiment, the circuit 14 (FIGS. 1-3) of the apparatus 10 comprises a tire pressure monitoring circuit 14 with the components 16 being selected to provide pressure sensing and signal transmitting functions. The tire pressure monitoring wireless device 102, mounted on the vehicle wheel, monitors tire pressure and transmits a wireless signal 108 (e.g., a radio frequency signal) to the vehicle system 104 which, in this case, may include a warning lamp on a vehicle instrument panel for warning a vehicle operator of a low tire pressure condition.

As another example, in one particular embodiment, the wireless device 102 may comprise a remote keyless entry (“RKE”) device for a vehicle. In this embodiment, the circuit 14 (FIGS. 1-3) of the apparatus 10 comprises a remote keyless entry control circuit 14 with the components 16 being selected to provide vehicle security control functionality, such as vehicle lock/unlock control functions, security alarm control functions, door open/close control functions, trunk open/close control functions, window open/close control functions, etc. In this embodiment, the housing 112 of the RKE wireless device 102 may comprise a key fob for attachment to a key ring or may comprise a portion of a vehicle key. The other components 106 of the RKE wireless device 102 may include pushbuttons for activating the various control functions of the RKE control circuit 14. The RKE wireless device 102, when actuated via the pushbuttons 106, provides a wireless signal 108 that communicates with the appropriate vehicle system 104 which, in this case, may include a vehicle security system, door locks, door open/close latches and/or motors, and window open/close motors.

From the above description of the invention, those skilled in the art will perceive improvements, changes and modifications. Such improvements, changes and modifications within the skill of the art are intended to be covered by the appended claims.

Having described the invention, the following is claimed:

1. An apparatus comprising:
a battery comprising a positive terminal and a negative terminal;
at least one layer of electrical insulating material disposed on one of said positive and negative terminals; and
at least one electrically conductive circuit layer disposed on said at least one layer of electrical insulating material.

2. The apparatus of claim 1, wherein said positive terminal comprises a top casing of said battery and said negative terminal comprises a bottom casing of said battery.

3. The apparatus of claim 2, wherein said top and bottom casings are isolated from each other by an electrical insulating material.

4. The apparatus of claim 2, wherein said battery further comprises an electrolyte material disposed between said top and bottom casings.

5. The apparatus of claim 1, wherein said at least one electrically conductive circuit layer comprises a ground plane disposed on one of said at least one layers of electrical insulating material.

6. The apparatus of claim 5, further comprising means for providing an electrical connection between said ground plane and said negative terminal.

7. The apparatus of claim 1, wherein said at least one electrically conductive circuit layer comprises a positive trace layer disposed on one of said at least one layers of electrical insulating material.

8. The apparatus of claim 7, further comprising means for providing an electrical connection between said positive trace layer and said positive terminal.

9. The apparatus of claim 8, wherein said positive trace layer and said at least one layer of electrical insulating material are disposed on said positive terminal of said battery, said means for providing an electrical connection comprising a portion of said positive trace layer electrically connected to said positive terminal through said at least one layer of electrical insulating material.

10. The apparatus of claim 8, wherein said positive trace layer and said at least one layer of electrical insulating material are disposed on said negative terminal of said battery, said means for providing an electrical connection comprising a strap having a portion connected to said positive terminal and a portion connected to said positive trace layer.

11. The apparatus of claim 1, wherein said at least one electrically conductive circuit layer comprises a negative trace layer disposed on one of said at least one layers of electrical insulating material.

12. The apparatus of claim 11, further comprising means for providing an electrical connection between said negative trace layer and said negative terminal.

13. The apparatus of claim 12, wherein said negative trace layer and said at least one layer of electrical insulating material are disposed on said negative terminal of said battery, said means for providing an electrical connection comprising a portion of said negative trace layer electrically connected to said negative terminal through said at least one layer of electrical insulating material.

14. The apparatus of claim 12, wherein said negative trace layer and said at least one layer of electrical insulating material are disposed on said positive terminal of said battery, said means for providing an electrical connection comprising a strap having a portion connected to said negative terminal and a portion connected to said negative trace layer.

15. The apparatus of claim 9, further comprising means for providing an electrical connection between said negative trace layer and a ground plane.

16. The apparatus of claim 15, wherein said means for providing an electrical connection comprises a portion of said negative trace layer electrically connected to said ground plane through a layer of electrical insulating material disposed between said negative trace layer and said ground plane.

17. The apparatus of claim 1, wherein said at least one layer of electrical insulating material and said at least one electrically conductive circuit layer are disposed on said battery via thick film printing.

18. The apparatus of claim 1, wherein said at least one electrically conductive circuit layer comprises a thick film printed silver trace material.

19. The apparatus of claim 1, wherein said battery comprises a coin battery.

20. The apparatus of claim 1, wherein said battery comprises a lithium ion battery.

21. The apparatus of claim 1, further comprising at least one circuit component mounted on said battery and electrically connected to said at least one electrically conductive circuit layer.

22. The apparatus of claim 21, wherein said at least one circuit component is connected to said at least one electrically conductive circuit layer via soldering.

23. The apparatus of claim 22, wherein said soldering comprises at least one of selective soldering and reflow soldering.

24. An apparatus comprising:
a battery comprising a positive terminal and a negative terminal; and
a printed circuit formed on at least one of said positive and negative terminals.

25. The apparatus of claim 24, wherein said printed circuit is formed with thick film printing.
